(19) United States
(12) Patent Application Publication
(10) Pub. No.: US 2009/0321087 A1
(43) Pub. Date: Dec. 31, 2009

(54) EXPANDABLE PLUG

(75) Inventor: Herman Victorov, Windsor (CA)

Correspondence Address: HARNESS, DICKEY & PIERCE, P.L.C., P.O. BOX 828, BLOOMFIELD HILLS, MI, 48303, US

(73) Assignee: Electrical/Electronic Mechanical Industrial Equipment Ltd., Windsor (CA)

(21) Appl. No.: 12/480,997

(22) Filed: Jun. 9, 2009

Related U.S. Application Data
(60) Provisional application No. 61/122,004, filed on Dec. 12, 2008.
(60) Provisional application No. 61/076,279, filed on Jun. 27, 2008.

(51) Int. Cl. E21B 33/12; B05D 7/00

(52) U.S. Cl. 166/386; 427/215; 264/319; 166/192

(57) ABSTRACT

An absorbent charge for plugging a well includes a plurality of bentonite particles intermixed with a water-soluble binding agent. The mixture of bentonite particles and binding agent are compressed to define the charge. Alternatively, an absorbent charge may include a plurality of bentonite particles encapsulated by a water-soluble shell. Methods of manufacturing and delivering the charges are also discussed.

### CROSS-REFERENCE TO RELATED APPLICATIONS

This application claims the benefit of U.S. Provisional Application Nos. 61/122,004 filed on Dec. 12, 2008 and 61/076,279, filed on Jun. 27, 2008. The entire disclosures of each of the above applications are incorporated herein by reference.

### FIELD

The present disclosure generally relates to plugging decommissioned wells. In particular, an improved plugging charge, as well as methods of manufacturing and delivering the improved plugging charge are discussed.

### BACKGROUND

The statements in this section merely provide background information related to the present disclosure and may not constitute prior art.

The extraction process for crude oil typically includes forming an oil well by drilling a hole into the ground. Once the hole is drilled, a tubular casing is placed in the hole and secured in position under geological pressure. The casing provides a path for extracting the crude oil to the surface. When the well is no longer being used for crude oil extraction, it may be plugged by inserting a plugging material into the casing to prevent the crude oil from contaminating the surroundings.

It is known in the art to utilize concrete in the well-plugging process. While widely used, concrete can fail to seal due to potential crack development from ground movement or tectonic activity. Crack development creates the potential for environmental risks including gas and crude oil seepage out of the casing, as well as ground water contamination from either crude oil or pollutants being injected from the surface opening.

More recently, efforts by others have lead to the utilization of bentonite (sodium montmorillonite) in the well-plugging process. While the water-absorbing characteristics of bentonite and the bentonite plugging process have lead to an improvement in well-plugging practices, concerns relating to plugging failures still exist. In particular, bentonite expands when exposed to water. Some casings include substantially deep layers of water and oil positioned above a target location for the plug at or near the bottom of the well. Known processes may prematurely form plugs at locations above the target location due to the presence of water above the target plug location.

Additionally, some wells may extend over 1500 ft in depth. It may be desirable for a bentonite charge to withstand a well descent of this magnitude. Known bentonite delivery systems may break apart and allow premature water absorption and plug formation before the target location within the casing is reached. Unfortunately, the desired sealing effect may not be provided. As such, a need exists for an improved bentonite charge and delivery system.

### SUMMARY

An absorbent charge for plugging a well includes a plurality of bentonite particles intermixed with a water-soluble binding agent. The mixture of bentonite particles and binding agent are compressed to define the charge.

Additionally, an absorbent charge may include a plurality of bentonite particles compressed to form a solid body. A water-soluble shell encapsulates the body.

A method of manufacturing an absorbent charge includes mixing bentonite particles with a water-soluble binding agent. The mixture is compressed to form a solid structure.

Another method of manufacturing an absorbent charge includes encapsulating bentonite particles with a water-soluble shell.

The present disclosure also provides a method of plugging a well. The method of plugging the well includes forming a charge of bentonite resistant to expansion upon initial contact with water. The charge is dropped in the well. The charge contacts the water. The charge is delivered to a target location below a location where the charge first contacts the water. The bentonite is exposed to the water. Water is absorbed by the exposed bentonite causing the bentonite to expand in volume and form a plug at the target location.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a simplified, cross-sectional view of a well including a plug;

FIG. 2 is a fragmentary perspective view of a representative absorbent charge;

FIG. 3 is a cross-sectional perspective view of another representative absorbent charge;

FIG. 4 is a cross-sectional view of a mechanism for forming the charge;

FIG. 5 is a fragmentary perspective view of another representative absorbent charge;

FIG. 6 is a cross-sectional view of an overmolding mechanism for encapsulating bentonite particles with a water-soluble shell;

FIG. 7 is a cross-sectional view of a dipping mechanism for encapsulating bentonite particles with a water-soluble shell;

FIG. 8 is a perspective view of a spraying mechanism for encapsulating bentonite particles with a water-soluble shell; and

FIG. 9 is a perspective view of another representative absorbent charge.

### DETAILED DESCRIPTION

The following description is merely exemplary in nature and is not intended to limit the present disclosure, application, or uses. It should be understood that throughout the drawings, corresponding reference numerals indicate like or corresponding parts and features.

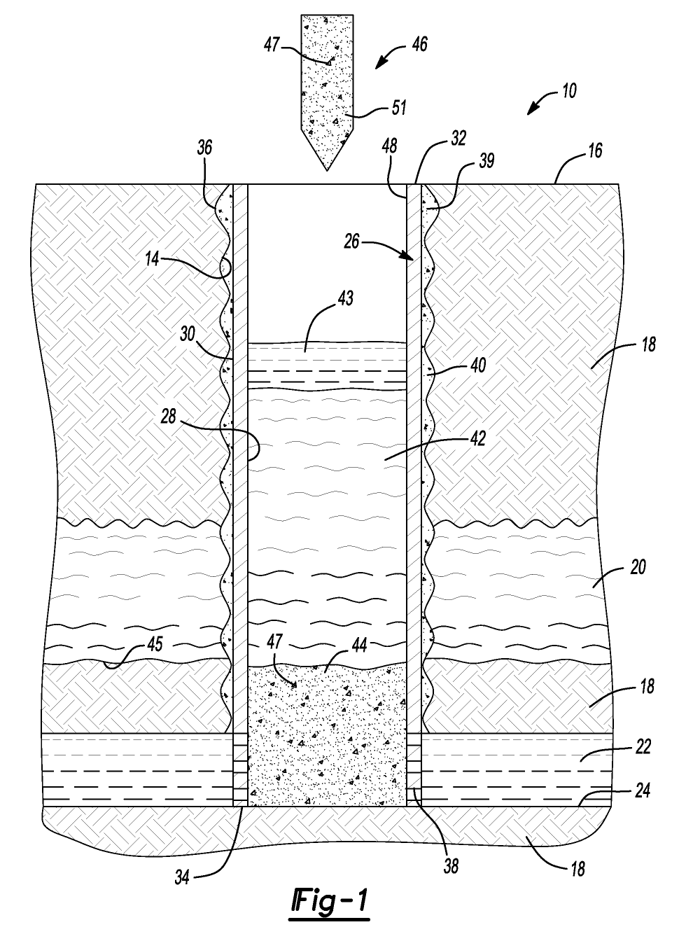

As can best be observed in FIG. 1, an exemplary well is identified at reference numeral 10. Well 10 includes a bored hole 14, that begins at a surface level 16, extends downwardly through various levels of earth 18, groundwater 20 and crude oil 22, and terminates at a bottom surface 24. When initially constructing well 10, a tubular casing 26 is inserted into bored hole 14 and extended downwardly to bottom surface 24. Bottom surface 24 may be 1500 feet or more below surface level 16.

Tubular casing 26 is substantially cylindrically-shaped including an inner surface 28, an outer surface 30, a first end 32 and a second end 34. First end 32 is positioned at or near surface level 16. Second end 34 is positioned at or near bottom surface 24. Tubular casing 26 is secured in position by geological forces provided by walls 36 of bored hole 14. Additionally, it may be desirable to establish a seal between outer surface 30 and walls 36 of bored hole 14 by injecting a grout mixture 39 into a space 40 formed between outer surface 30 of tubular casing 26 and walls 36 of bored hole 14 during insertion of tubular casing 26. A plurality of apertures 38 extend radially through tubular casing 26 between inner surface 28 and outer surface 30. Apertures 38 are formed near second end 34 in communication with crude oil 22. Apertures 38 provide an entrance for crude oil 22 to be pumped through tubular casing 26 from second end 34 to surface level 16.

After use, it may be desirable to decommission well 10. Tubular casing 26 may contain a layer of water 42 and a layer of oil 43 located above apertures 38. To assure that crude oil 22 does not contaminate groundwater 20, a plug 44 is formed within tubular casing 26 at a predetermined target location axially positioned between apertures 38 and a lower surface 45 of groundwater 20. Plug 44 is formed in tubular casing 26 by inserting one or more absorbent charges 46 into an opening 48 formed at first end 32 of tubular casing 26. Opening 48 may have a diameter ranging from 5 to 30 inches. Absorbent charge 46 may be carried by force of gravity from first end 32 to second end 34. Charge 46 is formed, as will be described in greater detail, to temporarily resist absorption of water to allow the charge to reach the target location prior to forming a plug.

Absorbent charge 46 may be comprised of bentonite particles 47 and a water-soluble binding agent 51. Water-soluble binding agent 51 may take a variety of forms including but not limited to a gelatin, a glue, etc. Water-soluble binding agent 51 binds the bentonite particles 47 to one another to form a durable, solid structure. The structural integrity of charge 46 is maintained while falling to second end 34 of tubular casing 26. After a predetermined amount of time, at least a portion of water-soluble binding agent 51 dissolves to expose the bentonite to the water. At this time, bentonite particles 47 absorb water and expand. As such, a properly located plug 44 is formed.

Bentonite is also known as sodium monmorillonite and may be loosely classified as an impure clay. Bentonite exhibits an expansive effect when exposed to water such that up to a fifty percent increase in volume may occur. Bentonite particles 47 may be formed by any number of processes including grinding, chipping, pulverization and the like. The size of the bentonite particles may range from ¼ inch to 1 inch with a particle size of ½ inch being beneficial for plug formation.

Water-soluble binding agent 51 may include a gelatin similar to the soft gel capsule material defined by U.S. Pat. No. 7,247,010, herein incorporated by reference. It should be appreciated that other binding agents may be used without departing from the scope of the present disclosure.

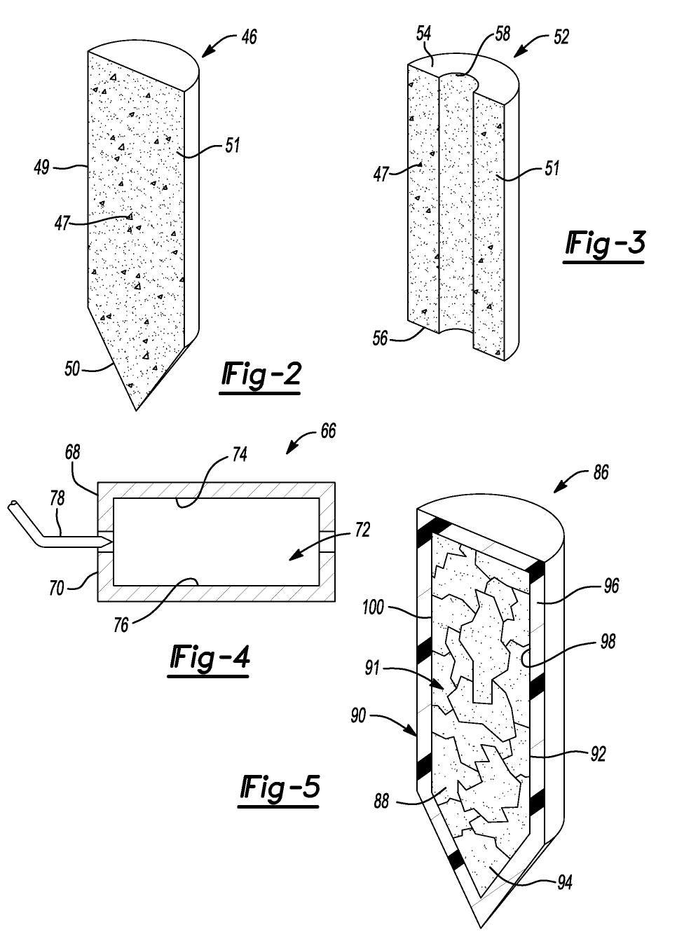

FIG. 2 depicts absorbent charge 46 in greater detail. Absorbent charge 46 may include a substantially cylindrically-shaped body 49 integrally formed with a conically-shaped nose portion 50. The bullet shape assists penetration of water layer 42 and oil layer 43 by charge 46, as well as to better position itself between other charges. In at least one version, a diameter of body 49 may range between 2 and 6 inches. A length of absorbent charge 46 may range between 7 and 20 inches.

FIG. 3 depicts an alternate charge 52 having a substantially cylindrical shape. Charge 52 is also formed from bentonite particles 47 and binding agent 51. Charge 52 has substantially planar end surfaces 54, 56. If multiple charges 52 are required to plug well 10, one of end surfaces 54, 56 of a first charge may be placed in engagement with one of end surfaces 54, 56 of a second charge to efficiently stack the charges within tubular casing 26. Charge 52 also includes a bore 58 longitudinally extending therethrough. Bore 58 allows liquid to pass through charge 52 as it descends within case 26, thereby decreasing the time required for charge 52 to reach a desired plug forming location. The presence of bore 58 also increases the quantity of surface area exposed to liquid within well 10. The time required for plug formation may be decreased due to the hydration of bentonite particles 47 occurring more rapidly. Depending on the application, it is contemplated that the diameter of bore 58 may range between 0.75″ to 1.50″. The bore diameter increases as the plug outer diameter increases. Furthermore, it should be appreciated that any of the charge configurations discussed in this paper may include a throughbore, if desired.

Referring to FIG. 4, absorbent charge 52 may be formed in a hydraulic press 66. Press 66 includes a first die 68 moveable relative to a second die 70. A cavity 72 is defined by a surface 74 of first die 68 and a surface 76 of second die 70. A mixture of bentonite particles 47 and water-soluble binding agent 51 is introduced into cavity 72 through a nozzle 78. It should be appreciated that the mixture of bentonite particles 47 and water-soluble binding agent 51 may be added to cavity 72 by means other than nozzle 78, or mixed directly in cavity 72. To facilitate mixing, water-soluble binding agent 51 may be heated to allow the binding agent to more easily flow. Absorbent charge 52 is formed by moving first die 68 and second die 70 toward one another to compress the mixture of bentonite particles 47 and water-soluble binding agent 51. After compression, absorbent charge 52 is removed from cavity 72.

Another absorbent charge 86 is shown in FIG. 5. Absorbent charge 86 is comprised of bentonite particles 88 encompassed by a water-soluble shell 90. Bentonite particles 88 may be compressed to form a bullet-shaped structure 91 having a cylindrically-shaped body 92 integrally formed with a conical nose portion 94. Water-soluble shell 90 may take a variety of forms including but not limited to a gelatin, a glue, etc. Water-soluble shell 90 secures the bentonite particles 88 therein and forms a durable, solid covering whose structural integrity is maintained while charge 86 is falling to second end 34 of tubular casing 26. Shell 90 includes a substantially constant thickness wall 96 having an inner surface 98 engaging an outer surface 100 of structure 91. After a predetermined amount of time, water-soluble shell 90 dissolves to ensure timely formation of a properly located plug 44.

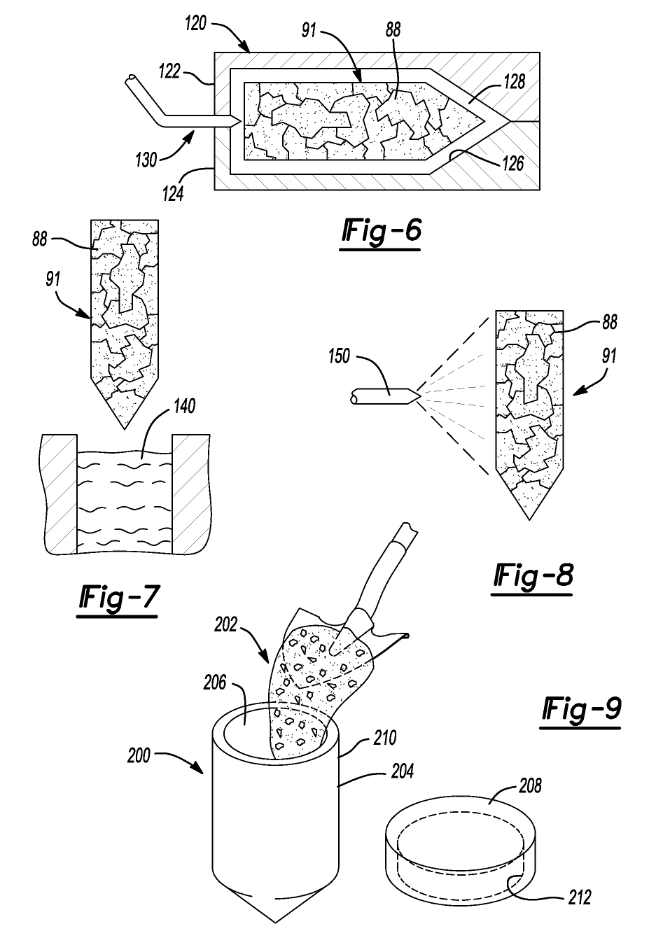

Referring to FIG. 6, structure 91 may be formed in a press substantially similar to press 66. Subsequently, structure 91 may be transferred to a molding machine 120 including a first half 122 and a second half 124 defining a cavity 126. First half 122 and second half 124 are moveable relative to one another. Cavity 126 is sized and shaped to provide a gap 128 surrounding structure 91.

A nozzle 130 introduces a liquid form of water-soluble shell 90 into cavity 126 to fill gap 128 and encapsulate structure 91. Absorbent charge 86 is formed upon solidification of water-soluble shell 90. It should be appreciated that the encapsulation of structure 91 with water-soluble shell 90 may be completed by a variety of different processes, including but not limited to a dipping process as depicted in FIG. 7 where structure 91 is immersed in a bath 140 of liquid form water-soluble shell material.

FIG. 8 depicts a spraying process where a nozzle 150 sprays a liquid form of water-soluble shell material on structure 91 to define a shell encompassed bentonite charge. Alternatively, shell 90 may be formed as a soft gel capsule described by U.S. Pat. No. 7,247,010. The '010 patent describes producing a soft gel capsule from gelatin in a molten state that is spread and cooled to form two continuous flexible gelatin films/sheets/ribbons that are subsequently joined together with a fill material injected therebetween.

Another alternative absorbent charge 200 may be formed by a filling process as shown in FIG. 9. Absorbent charge 200 is formed by transferring bentonite particles 202 to a previously manufactured water-soluble capsule 204. Bentonite particles 202 may be transferred to water-soluble capsule 204 through an aperture 206 formed in water-soluble capsule 204. After transferring bentonite particles 202 through aperture 206, a cover 208 is sealingly engaged with capsule 204 to close aperture 206 and capture bentonite particles 202 in water-soluble capsule 204. Cover 208 may include any number of shapes including a disk or a hollow tube having one closed end. Cover 208 may be secured to capsule 204 by locally melting portions of cover 208 and/or capsule 204. Adhesives or liquid capsule material may also be used to complete the joint. Alternatively an outer surface 210 of capsule 204 may be press fit with an inner surface 212 of cover 208 to sealingly capture bentonite particles 202 therein.

While a number of charge embodiments and methods for making and delivering the charges have been described, it should be appreciated that other bentonite charges having an initial resistance to expansion while traveling toward the bottom of the well are within the scope of the present disclosure. For example, the charges may be shaped as elongated tapered structures having an oval or elliptical profile in addition to the cylindrical or bullet shapes previously described. Furthermore, the foregoing discussion discloses and describes merely exemplary embodiments of the present disclosure. One skilled in the art will readily recognize from such discussion, and from the accompanying drawings and claims, that various changes, modifications and variations may be made therein without departing from the spirit and scope of the disclosure as defined in the following claims.

What is claimed is:

1. An absorbent charge for plugging a well, comprising:
a plurality of bentonite particles; and
a water-soluble binding agent intermixed with the plurality of bentonite particles, the mixture of the bentonite particles and binding agent being compressed to define the charge.

2. The absorbent charge of claim 1 wherein the charge includes a substantially cylindrically-shaped body integrally formed with a conical nose portion.

3. The absorbent charge of claim 1 wherein the shape of the charge includes a cylinder.

4. The absorbent charge of claim 1 wherein the charge includes a longitudinally extending throughbore.

5. An absorbent charge comprising:
a plurality of bentonite particles compressed to form a solid body; and
a water-soluble shell encapsulating the body.

6. The absorbent charge of claim 5 wherein the body is cylindrically-shaped.

7. The absorbent charge of claim 5 wherein the charge includes a conical nose portion integrally formed with the body, the shell encompassing the body and the nose portion.

8. The absorbent charge of claim 6 wherein the water-soluble shell includes a substantially constant thickness.

9. The absorbent charge of claim 6 wherein the water-soluble shell is a two-piece capsule and the bentonite particles are free to move within the closed two-piece capsule.

10. A method of manufacturing an absorbent charge, comprising:
mixing bentonite particles with a water-soluble binding agent; and
compressing the mixture to form a solid structure.

11. The method of claim 10 wherein compressing the mixture includes positioning the mixture in a cavity of a die and applying a force to the die.

12. The method of claim 10 further including heating the water-soluble binding agent.

13. A method of manufacturing an absorbent charge, comprising:
providing bentonite particles;
encapsulating the bentonite particles with a water-soluble shell.

14. The method of claim 13 wherein bentonite particles are formed by one of the steps including grinding, chipping and pulverizing.

15. The method of claim 13 further including compressing the bentonite particles into a solid core prior to encapsulation.

16. The method of claim 15 wherein encapsulating the bentonite particles includes positioning the core in a mold and overmolding the solid core with a liquid form of the water-soluble shell.

17. The method of claim 15 wherein encapsulating the solid bentonite core includes spraying the core with a liquid form of the water-soluble shell.

18. The method of claim 15 wherein encapsulating includes dipping the solid core into a liquid form of the water-soluble shell.

19. The method of claim 13 further including forming a hollow capsule, wherein encapsulating the bentonite particles includes positioning the bentonite particles in the hollow capsule and sealingly closing an aperture of the capsule to form the water-soluble shell.

20. A method of plugging a well, the method comprising:
forming a charge of bentonite resistant to expansion upon initial contact with water;
dropping the charge into the well;
contacting the charge with water;
delivering the charge to a target location below a location where the charge first contacted water;
exposing the bentonite to water;
absorbing water with the exposed bentonite; and
expanding the volume of the bentonite to form a plug at the target location.

21. The method of claim 20 wherein forming the charge of bentonite resistant to expansion includes mixing bentonite particles with a water-soluble binding agent.

22. The method of claim 21 wherein forming the charge includes compressing the mixture of bentonite particles and binding agent.

23. The method of claim 21 wherein exposing the bentonite to water includes dissolving a portion of the water-soluble binding agent.

24. The method of claim 20 wherein forming the charge of bentonite resistant to expansion includes encompassing bentonite particles with a water-soluble shell.

25. The method of claim 20 wherein forming the charge includes forming a hollow water-soluble capsule, positioning bentonite particles within the capsule and sealing the capsule.

26. The method of claim 20 wherein forming the charges includes forming a bore longitudinally extending through the charge.
